(19) United States
(12) Patent Application Publication
(10) Pub. No.: US 2022/0261851 A1
(43) Pub. Date: Aug. 18, 2022

(54) SYSTEM AND METHOD FOR PERFORMING MONETIZATION PROGRAMS THROUGH OWN BRANDING

(71) Applicant: ROLAND ATHOURIS II, GRAYSON, GA (US)

(72) Inventor: ROLAND ATHOURIS II, GRAYSON, GA (US)

(21) Appl. No.: 17/177,348

(22) Filed: Feb. 17, 2021

(51) Int. Cl. G06Q 30/02; G06Q 50/00

(52) U.S. Cl. CPC G06Q 30/0267; G06Q 50/01; G06Q 20/36; G06Q 30/0203; G06Q 30/0204

(57) ABSTRACT

Active learning and advanced relationship marketing are employed with respect to a mobile marketing system. A relationship between an advertiser and a consumer can become smarter over time as a function of interaction as well as non-interaction. Further, affinity groups or micro segments can be identified to aid tailoring of advertisements to consumers. Consumers can additionally be engaged in a dialog to acquire additional information and/or feedback data to develop a further understanding of specific consumers. Still further yet, assistance can be provided to advertisers so that advertisements can be customized for needs of potential customers.

### FIELD OF THE INVENTION

The present invention relates to field of marketing efforts. More particularly, the present invention relates to a system and method for evaluating the cause and effect of advertising and marketing programs using branding and reward program selection.

### BACKGROUND OF THE INVENTION

Marketing and more specifically advertising has changed over time with technology. At one time, television, radio, and mail were the primary means for advertising. Accordingly, advertising was accomplished by way of commercials and direct mailings. With the advent of the Internet, advertisers were afforded additional dissemination mechanisms including e-mail and search. Consequently, advertisements are now also provided in the form of or within e-mail, embedded with Web pages, and proximate to or as search results, among other things. The proliferation of mobile devices now provides advertisers with yet another way to reach potential customers. Further yet, advertisers are now seeking to exploit location information enabled by many mobile devices. Such functionality is often referred to as a location-based service (LBS) or alternatively location-based advertising (LBA). Location-based services supply information as a function of the geographical position of a mobile device. One or more location mechanisms can be utilized by such services including GPS, triangulation, and local proximity technologies such as Bluetooth, infrared, wireless local area network (WLAN), and radio frequency identification (RFID), among other things. Applications can then utilize the determined location to aid navigation or focus search results. Moreover and as previously mentioned, advertisements or the like can be transmitted to users based on their location as determined via their mobile device. For example, when a mobile phone is determined to be within a specified distance of a restaurant, a text message can be sent to the user including a promotional code associated with some discount, such as 10% off a meal or a free appetizer with the purchase of two entrees.

### BRIEF SUMMARY OF THE INVENTION

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains generally to active learning and advanced relationship marketing in the context of a marketing system or service. Here, mechanisms are provided for engaging consumers in an ongoing dialog with a mobile marketing system or service to collect pertinent information. Dialog information amongst other acquired information such as transactional activity can be utilized to form a learning relationship between a consumer and advertiser that develops and changes over time with every interaction as well as non-interaction. Consequently, advertisements can be increasingly tailored and consumers are more precisely differentiated.

In accordance with one aspect of the invention there provided a method for providing white label network branding to control monetization program by using internet and mobile websites and related mobile device or computer systems comprising promotions, online coupons, mobile services, Products, Goods & Services, and related company and local information, using a mapping platform using multi-dimensional and scalable mapping, wherein electronically assigning on a computer system an identifier to a client mobile device or computer receiving a request and electronically providing on a mobile device or computer system access to said websites or links that provide mapping combination of integrated social networking, social networking communities, social networking activities, user profiles and electronically connected by mobile App management which allow subscribers or their private communities the ability to download, share, and have direct access to exclusive content that can be monetized to their community or subscribers and electronically connected to subscribers by Advertisement that control and manage the advertisements that your subscribers or community view on their dashboard and electronically connected to subscribers by way of Virtual learning management by which subscribers can create own university course study in business and leadership, photography, cooking, writing, acting, music, sports and more and electronically connected to subscribers by way of providing Content management which can be managed by branding “Paid Subscribers”, “Privilege Customers” and managing the content in the platform and electronically connected to subscribers by way of Campaign Themes and Capture pages, also connecting the subscribers by way of online questionnaires and electronically connected to subscribers by way of community posting and sharing and electronically connected to subscribers by way of content library to access the latest uploads, videos, media uploaded by the platform owner and electronically connected to subscribers by way of Campaign analytics and electronically connected to subscribers by way of E-wallet management via a dashboard which can access via your mobile phone or computer, wherein the wallet shall manage the rewards, digital currency and act as a payment to subscribers and community for referral commission payments and rewards, closed looped e-wallet platform will be for “netWO” rewards, payments and incentive programs to build communities and revenue channels, with an integrated payment gateway for crypto and fiat payments and overrides. This will be used to determine a brands worth to netWO. NetWO can choose to share profits based on the netWO brand valuation calculator. “netWO Brand Valuation Calculator” determines the valuation of the brand.

In accordance with a particular aspect of the disclosure, affinity groups or the like can be formed, and consumers can be moved into or out of groups as a function of newly acquired information, for instance. Predictions about what a consumer is likely to need or desire can then be made based on group membership. In this manner, an advertisement can be identified and provided to a consumer based on a likely need or desire of which the consumer is not yet aware.

According to yet another aspect, advertisement assistance can be provided with respect to generating precisely targeted advertisements based at least in part upon a vast collection of knowledge acquired. By way of example and not limitation, recommendations can be made to advertisers upon detection of an unmet need or desire to facilitate generation of an advertisement that addresses the need or desire. Additionally, concept testing can be performed and advertiser questions answered.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

Various embodiments of the invention will, hereinafter, be described in conjunction with the appended drawings provided to illustrate, and not to limit the invention, wherein like designations denote like elements, and in which:

FIG. 1 is a block diagram of a mobile marketing support system in accordance with an aspect of the disclosed subject matter.

FIG. 2 is a block diagram of a representative dialog component according to a disclosed aspect.

FIG. 3 is a block diagram of a representative analysis component in accordance with an aspect of the disclosure.

FIG. 4 is a block diagram of a representative advertisement component in accordance with an aspect of the disclosure.

FIG. 5 is a block diagram of a mobile marketing system in accordance with an aspect of the subject disclosure.

FIG. 6 is a block diagram of a representative consumer interface component according to a disclosed aspect.

FIG. 7 is a block diagram of a representative advertiser interface component in accordance with an aspect of the disclosure.

FIG. 8 is a block diagram of a representative consumer interface component according to a disclosed aspect.

FIG. 9 is a flow chart diagram of a method of offer redemption in accordance with a disclosed aspect.

FIG. 10 is a schematic block diagram of a sample-computing environment.

FIG. 11 is a schematic block diagram of the list of concept.

### DETAILED DESCRIPTION OF THE INVENTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

Exemplary embodiments of the present technique that provides a method and system more particularly to a financial management system that utilizes conventional personal digital assistants for input by servers and output to servers.

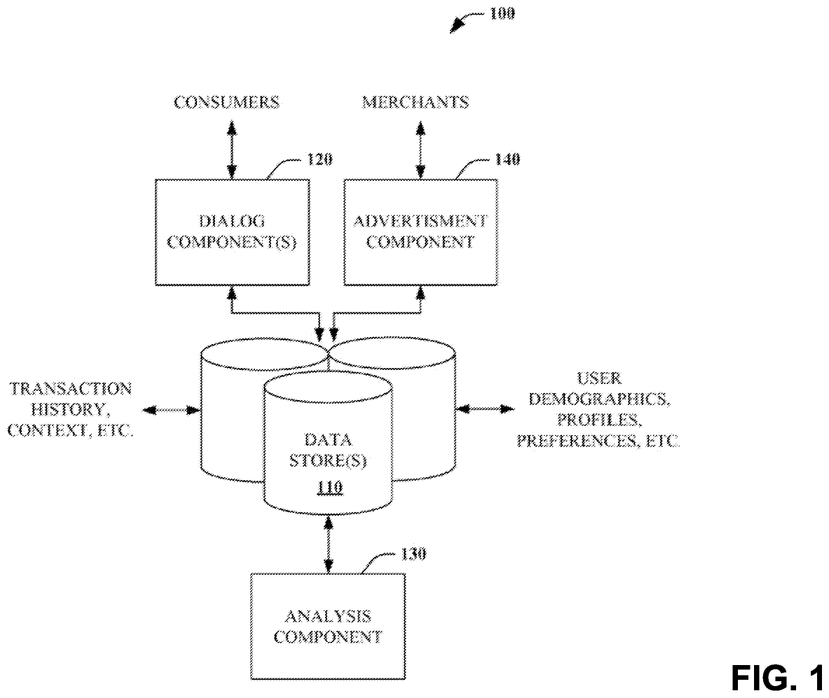

Referring initially to FIG. 1, a mobile marketing support system 100 is illustrated in accordance with an aspect of the claimed subject matter. In particular, the system 100 includes one or more data stores 110 that house advertiser and user or consumer information, among other things. For example, such information can include, without limitation, demographic information, context information (e.g., location, extrinsic data . . . ), transaction history, and/or personal health data.

The information can be acquired by an associated system, component thereof or a third-party service. Furthermore, information can be produced as a function of other information or data. As will be described in further detail infra, information persisted to one or more data stores 110 can be employed to facilitate matching of advertisements to users with respect to a mobile marketing system.

The system 100 can also include one or more dialog components 120 (e.g., online, mobile device) communicatively coupled with data store(s) 110. A dialog component 120 engages a user or consumer in a dialog to acquire pertinent information that can aid a mobile marketing system. More specifically, the dialog component 120 can acquire additional information, or feedback, from users including, without limitation, opinions, attitudes, likes, dislikes, and preferences. Further, feedback can be specified with respect to a mobile marketing system, an advertiser, an advertisement, and/or a product or service, among other things. While a user can explicitly enter information such as a profile, preferences, or settings, for example upon mobile marketing system setup, the dialog component 120 allows information to be continually collected, for example upon naturally occurring events, among other things. Furthermore, it should be appreciated that such customer feedback data can be integrated with transaction data and member profile and preference information to facilitate predictive analytics so that a resulting analysis include a complete understanding of member preferences, motivations, and intentions, as will be described further infra.

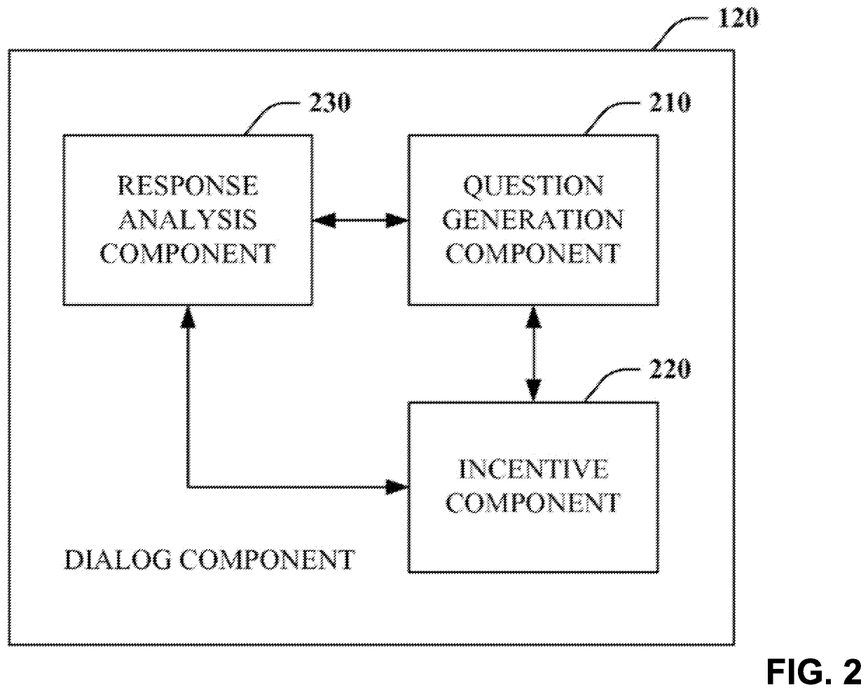

Turning attention to FIG. 2, a representative dialog component 120 is depicted in accordance with an aspect of the claimed subject matter. As shown, the dialog component 120 includes a question generation component 210, an incentive component 220, and a response analysis component 230.

The question generation component 210 generates or otherwise acquires questions for presentation to a user. For example, such a question could be “On a scale of 1-5, how would you rate your experience with a particular retailer?” or “How would you rate a provided offer?” In another embodiment, the question generation component 210 can produce a rating bar or like response tactic that can be employed to allow members to indicate their personal attitude, opinion, and/or satisfaction with an item, among other things. The rating bar tactic call use a displayed continue or next button that is represented by a continuous scale of colors progressing from green to red. This provides a richness of feedback without adding complexity to the user interface or interaction process.

The incentive component 220 can provide one or more mechanisms that encourage a user to participate in a dialog or to converse with a marketing system. A modest incentive can increase response rates dramatically. For instance, at a restaurant, a user can be asked to rate the food and/or service, and to encourage a response the incentive component 220 can offer a coupon to the user for a discount off the bill. In another instance, a user can be entered into a drawing for something such as a gift card, a car, or a vacation package. In this manner, a user can be encouraged to answer more than a current set of questions. Rather, the user is encouraged to continue dialog to increase the chances of winning some prize.

Of course, various other incentives or rewards can be employed to encourage user participation or investing in a relationship with a mobile marketing system. By way of example and not limitation, the incentive component 220 can also provide game functionality to motivate users to engage in a dialog. As an example, a user may earn points for responding to inquiries and users can strive to obtain a high score. Users can also be pitted against one another to compete for the best score, wherein the users are motivated by pride and/or a particular prize.

Further yet and in accordance with one embodiment, the incentive component 220 can ensure that incentives do not introduce respondent bias, where some members become more likely to respond than others do. The secret is to offer an incentive with universal appeal that all members may find equally attractive. Typical universally desired incentives include, without limitation, 1) entry into a prize drawing for an item or a cash prize; 2) award of points in a Rewards Program where the points can be redeemed for a promotional item with a mobile marketing system corporate logo, which not only encourages participation but also has a marketing and brand awareness advantage; 3) access to a small digital download, such as a ringtone, mobile video game or song; and 4) recognition in a “Members of the Week” section program. Additionally, when people feel they have an important stake in the types and quality of service offered they will often participate simply because it is in their own long-term best interest.

The response analysis component 230 can receive, retrieve or otherwise obtain or acquire a response to a question as well as analyze that response. For example, the component 230 can determine whether the response is valid, acceptable, and/or appropriate. Furthermore, the response analysis component 230 can work together with the question generation component 210 to enable intelligent follow-up questions to be asked and/or modification of the form of a question, for instance as a function of responses. Among other things, this enables more open-ended questions to be presented to a user, since the response analysis component 230 can interpret any response rather than simple scalar ratings. By way of example, consider gathering of feedback information about an offer. After a user has rated an offer, a subsequent question can be sent to the user concerning what the user liked or disliked about the offer based on the rating. Further, the user can be asked how the offer could be modified to make it more appealing to them or the like. It is also to be noted that the response analysis component 230 can be coupled to the incentive component to ensure that incentives are provided for responses or particular types of responses.

It is to be appreciated that the dialog component 120 or subcomponents thereof can be context aware. Accordingly, dialog can further utilize contextual information with respect question generation and the like. By way of example, the dialog component 120 can detect or infer a device that a user is employing and control the type or style of inquiry. For instance, where the device is a mobile device such as a phone, the dialog component 120 can utilize seek to acquire small discrete pieces of information utilizing one-off questions like rankings (e.g., rate experience on a scale of 1-10). Alternatively, if a user is employing a desktop computer or laptop a much more robust conversation can be initiated. For example, a survey or the like can be designed to build a robust three hundred and sixty degree view of the user.

Further still, since a mobile marketing system is transactional in natured, the dialog component 120 can make use of a perpetual survey in one embodiment where respondents are asked, to complete the survey immediately after a transaction. Regardless of survey administration frequency, a single respondent should not be asked to participate more than once a week, for example, to avoid respondent fatigue.

Returning briefly to FIG. 1, the marketing support system 100 includes an analysis component 130 communicatively coupled to the data store(s) 110. The analysis component 130 can execute various analytics or logic over various data including consumer profiles, preferences, and purchasing behavior to help advertisers drive highly targeted and effective advertisement campaigns and provide consumers with precisely tailored advertisements. Although not limited thereto, in one embodiment, the analysis component 130 can identify community likeness, affinity grouping, and/or market or micro segmenting.

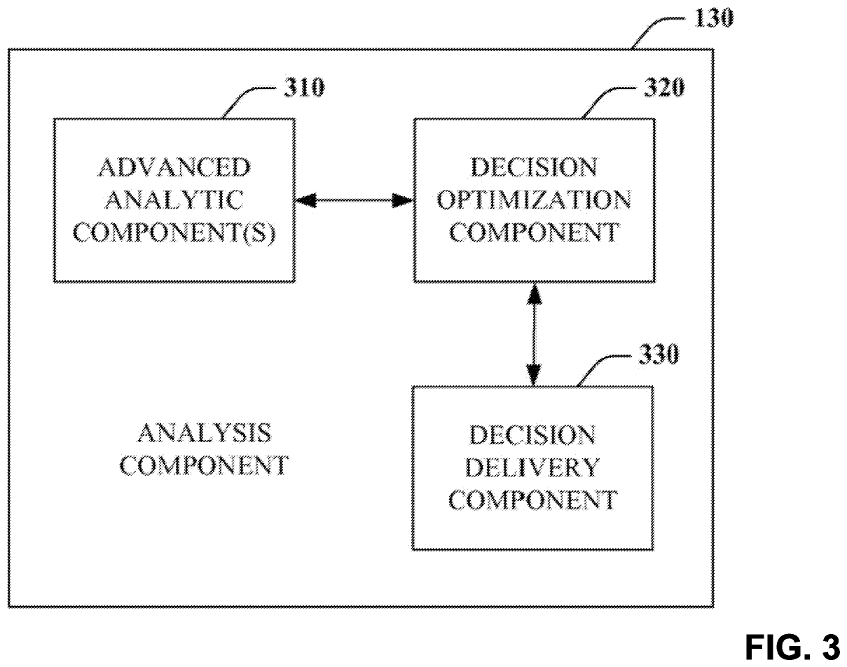

Turning attention to FIG. 3, a representative analysis component 130 is illustrated in accordance with an aspect of the claimed subject matter. Overall, the analysis component 130 can seek to provide actionable data that facilitates highly tailored and precise advertisement matching. In furtherance thereof, the analysis component 130 includes advanced analytic component(s) 310, decision optimization component 320, and decision delivery component 330. The advanced analytic component(s) 310 execute statistical, mathematical, and/or other algorithmic techniques that are used to examine the way in which specific issues relate to data on past, present, and future actions. The decision optimization component 320 analyzes actions to determine which actions will drive optimal outcomes. These “optimal actions” are delivered by the decision delivery component 330 to particular individuals, entities, systems, or the like that can perform the actions. In other words, the analysis component 130 can engage in predictive analysis to among other things reduce marketing costs, improve marketing return on investment, improve customer loyalty, and provide customer intimacy.

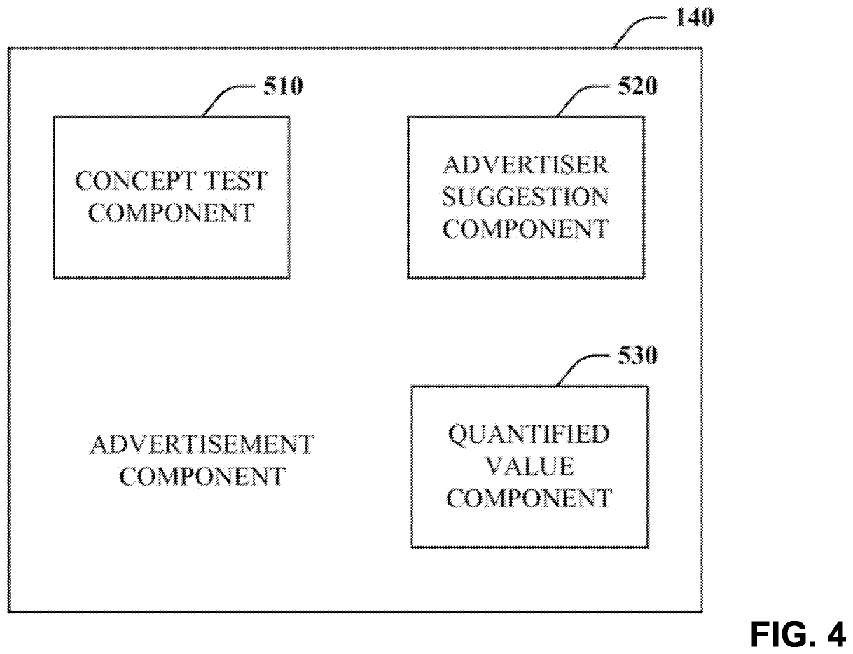

Referring to FIG. 4, a representative advertisement component 140 is shown according to an aspect of the claimed subject matter. The advertisement component 140 includes a concept test component 510 that facilitates testing of advertisements. Rather than simply designing an advertisement or advertising campaign and implementing it, the advertisement can first be tested. More specifically, and as will be described further with respect to a particular marketing system, the advertisement and profile associated therewith, for example, can be input into the system and matching users can be identified without actually providing the advertisement to the user. In this manner, the actual number of users that will receive this ad can be known. An advertiser can further alter an advertisement and a profile and/or settings associated with the advertisement and retest the advertisement. A cycle of advertisement modification and testing can continue until an advertiser is satisfied.

The advertisement component 140 can also include an advertiser suggestion component 140 that, among other things, provides suggestions or recommendations to an advertiser with respect to advertisement creation. The advertiser suggestion component 520 can analyze a plurality of data (e.g., profiles, preferences . . . ) stored with respect to numerous consumers and identifies where no match is being made. Stated differently, the component 520 can identify where there is a need or desire that is not being met. Once identified, the advertiser can be notified via suggestion or recommendation. In particular, the advertiser can be informed that if a particular advertisement is pushed out, it will reach a specific number of potential consumers. It is an advertisement or offer that the advertiser is not contemplating but of which a high push, conversion, and/or redemption rate can be guaranteed. Furthermore, if sufficient information is provided, the advertiser suggestion component 520 can automatically generate an advertisement, promotional offer of the like for presentation to the advertiser. Upon permission, the advertisement can be activated and pushed to potential consumers. Further yet, the advertiser can simply authorize pushing automatically generated advertisements to users within particular parameters (e.g., discount amount, product category) without additional confirmation.

Quantified value component 530 is also part of the advertisement component 140 to further aid provisioning of information to advertisers. In particular, the quantified value component 530 can analyze collected market data and provide quantified values for example in reports. The subject marketing support system seeks to receive, retrieve or otherwise obtain or acquire a substantial amount of information to aid in precisely tailoring advertisements to users as well as improving target advertising campaigns. In one instance, an advertiser can subscribe to a service from which reports can be generated and provided thereto to help them understand the current state of a market including perhaps the effectiveness and/or ineffectiveness of other advertiser's advertisement campaigns. Information can also be aggregated and presented to a user in a variety of manners to facilitate comprehension. Still further yet, the quantified value component 530 can answer specific advertiser questions as a function of collected data. For example, a question can pertain to the number of women over 35 in a particular area that have been responsive to offers for discounted salon products, and the quantified value component 530 can provide a numerical response to this query.

In accordance with one embodiment the quantified value component 530 can produce a market assessment designed to form a snapshot of a target market in terms of demographics (e.g., age, gender, income . . . ), psychographics (e.g., hobbies, interests, wants, needs, fears, aspirations . . . ) and behaviors (e.g., where they shop, when they shop, how often they go out, when they want to receive offers, how much money they spend . . . ). Once such information has been collected, advertisers have ample data to estimate response and return on investment of a potential advertisement.

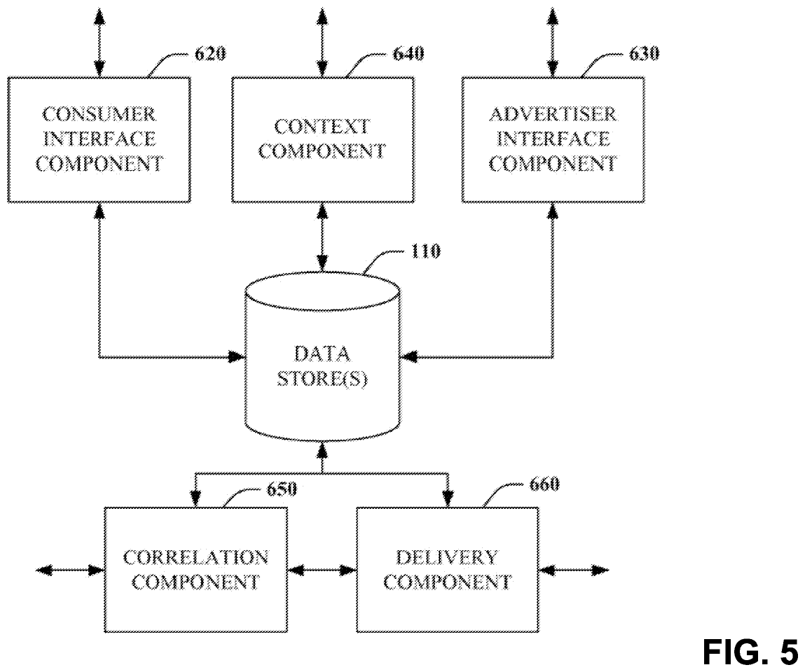

Turning attention now to FIG. 5, a mobile marketing system 600 within which aspects of the support system 100 of FIG. 1 can be employed in accordance with an aspect of the claimed subject matter. The system 600 includes one or more data stores 110 that house data pertaining to at least advertisers and consumers. The number, type, and configuration of data stores can vary. For example, the data store(s) 110 can be embodied as one or more database and data warehouse systems. Consumer interface component 620, advertiser interface 630, and context component 640 are communicatively coupled to the data store(s) 110 and provision different types of data for storage and subsequent employment to facilitate correlation and delivery of advertisements.

The consumer interface component 620 is a mechanism that facilitates collection of consumer or system user information. The extent of such information can vary but in general concerns at least identification of a user and a means for receiving advertisements. For example, a consumer can provide his/her name and specify a mobile computing device such as a mobile phone to receive advertisements. The consumer interface can also collect profile and/or preference information. A profile can include among other things, address, date of birth, gender, profession, income, ethnicity, religion, and/or group memberships. User preferences or settings can include, without limitation, categories of products/services of interest, companies of interest, keywords, advertisement delivery schedule (e.g., days of week, time of day . . . ), and means of notification and/or delivery (e.g., text message, email, local application . . . ). Alone or in combination, the user profile and/or preferences can act as advertisement filters for matching advertisements, as will be described further infra.

The advertiser interface component 630 is a mechanism that aids retrieval of advertiser related information such as advertiser or company, and advertisement or advertisement campaign information, among other things. For example, information can be collected regarding the location and/or particular stores for which advertisements or more specifically promotional offers will be valid. Further, advertisement interface component 630 can facilitate construction of a promotion and specification or particular preferences to control distribution such as category, keywords, and age range. Specifics regarding the promotion can also be acquired including when the advertisement will be sent and the total number of advertisements to be sent or variations thereof (e.g., impressions, views, activations . . . ). Such information can also be referred to as an advertisement or offer profile.

The context component 640 acquires and contributes context information to the data store(s) 110. Context relates generally to conditions that occur surrounding a consumer and/or advertiser, among other things. As will be discussed, further below, context can include, without limitation, user location information, and other extrinsic data. As will further be appreciated in light of later discussion, context provides yet another factor that can be considered when determining whether or not to provide a particular advertisement to a user.

The system 600 also includes correlation component 650 communicatively coupled to the data store(s) 110. The correlation component 650 can acquire data/information at least from the data store(s) 110 for use in correlating or matching advertisements to particular users. Matching can range from relatively simple to quite complex. For example, matching can be accomplished by determining whether or not a consumer and advertiser filters match. Additionally or alternatively, the correlation component 650 can engage in a more predictive assessment, for instance, where it infers matches as a function of a collection of information for which filters or preferences have not be explicitly identified. In one particular embodiment, the correlation component 650 can make predictions based on community likeness or affinity groups in which a user is deemed a member.

Delivery component 660 is communicatively coupled to the correlation component 650 as well as the data store(s) 110. Upon receipt or retrieval of matching advertisements from the correlation component 650, the delivery component 660 can deliver the advertisement or advertisement related information to a user by way of some computing device associated with the user. By way of example and not limitation, the delivery component 660 can send a text message (e.g., Short Message Service (SMS) communication), multimedia message (Multimedia Messaging Service (MMS) communication), e-mail (electronic mail), or an application message including the advertisement and/or information pertaining to the advertisement.

Further, the delivery component 660 can utilize information from the data store(s) 110 to determine if, when, and/or to which device the advertisement is sent. For example, a user may set preferences that dictate delivery. Additionally or alternatively, the delivery component 660 can determine or infer delivery specifics based on context information. For instance, if it can be determined that a user is likely skiing down a slope based on temperature, weather conditions, altimeter, and accelerometer data, the delivery component 660 would probably wait to transmit the advertisement until he/she is in line at a lift or in lodge café. Furthermore, where a user employs more than one device capable of receiving advertisements the delivery component 660 can also determine or infer to which device a user would prefer to receive an advertisement and send it to that device.

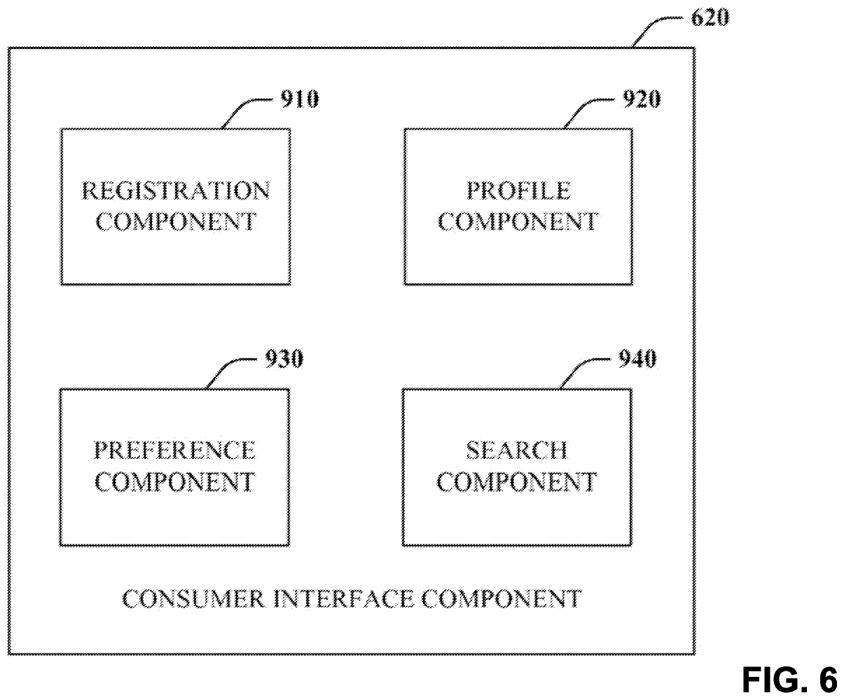

Referring to FIG. 6, a representative consumer interface component 620 is illustrated in accordance with an aspect of the claimed subject matter. The consumer component 620 provides a mechanism for a user or consumer to input data and interact with a mobile marketing system. As shown, the consumer component 620 includes a registration component 910, profile component 920, preference component 930, and search component 940.

The registration component 910 enables a user to register with a mobile marketing system and thereby make them eligible to receive advertisements. For example, the registration component 910 can afford one more graphical user interfaces or wizards to prompt users to enter such information as name, address, phone number, email or the like. A user account can subsequently be created after user information is validated, for instance by sending an email which includes an activation link.

The profile component 920 provides a mechanism for capturing user information about a user or a profile. For example, profile information can include similar things requested during registration as well as other information such as but not limited to birth date, gender, marital status, ethnicity, religion, group affiliations, profession, home ownership status, or other demographic information. Various other information can be entered that aid in defining and/or describing a user. Of course, none of this information is strictly necessary, but any profile information added can later be employed to facilitate location of relevant advertisements.

The preference component 930 facilitates input and receipt of user advertisement preferences or settings. By way of example and not limitation, a user can select categories and subcategories of goods and services of interest, and input keywords and brand/merchant preferences. Other settings can also include size of offers, maximum bid, frequency, privacy settings, temporary settings such as travel, vacation, expiration, and work, and a professional setting. Furthermore, a user can utilize the preference component 930 to specify delivery times and means of delivery and/or notification (e.g., email, SMS, MMS . . . ).

The search component 940 provides a mechanism to search for or otherwise locate advertisements of interest. More specifically, the search component 940 accepts advertisement queries in various forms and returns matching results. In other words, rather than sitting back and waiting for advertisements to be provided to them, users can proactively attempt to locate and acquire advertisements of interest.

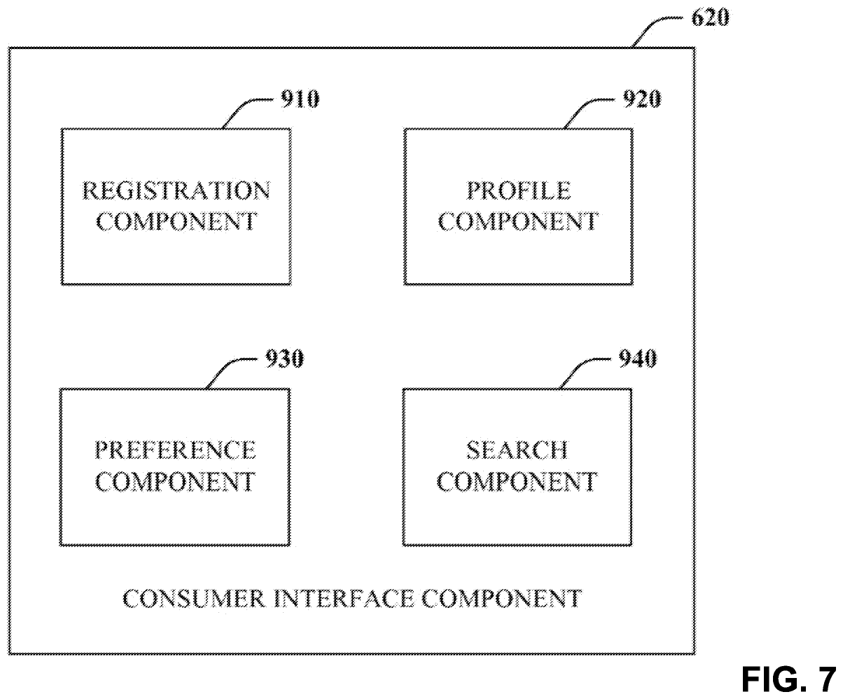

FIG. 7 depicts a representative advertiser interface component 630 in accordance with an aspect of the claimed subject matter. Similar to the consumer component 620, the advertiser component 630 includes a registration component 1010 and a profile component 1020. The registration component 1010 is a mechanism for registering an advertiser or creating an advertiser account. Information can be input utilizing one or more interfaces. Registration information can include, among other things, company name, federal tax id, address, phone, number contact person, and email. After such information is provided and validated via one or more mechanisms (e.g., e-mail activation, challenge response test . . . ), profile information can be entered in a like manner. In addition to registration information, profile information can include business structure information and the identification of additional store information (e.g., chain stores, franchises) and/or information about a particular advertisement or campaign.

The advertiser component 630 also includes an advertisement builder component 1030. As the name suggests, the advertisement builder component 1030 facilities construction of advertisements and/or advertising campaigns. Although not limited thereto, in accordance with one embodiment a series of graphical user interfaces can be presented to an advertiser that guides him/her through such a process. It should be appreciated that preferences or settings can be associated with advertisements at this point including such things as categories, subcategories, keywords, gender, age range, interests, and hobbies, among other things. Further yet, such settings can relate to advertisement and/or campaign validity including but not limited to validity dates (e.g., start date and end date), number of times a user can receive an advertisement, delivery schedule and maximum number of impressions. Together the preferences and settings relating to an advertisement can comprise an advertisement profile.

An advertisement generated by builder component 1030 can take any form that draws attention to or promotes some product or service. Accordingly, the advertisement can simply identify a product via image, audio, video, and/or scent for instance. However, advertisements that are more complex are contemplated including, without limitation, promotions, and/or use of coupons. Furthermore, presentation can differ. In one embodiment, promotional coupons can be produced that include either a promotional alphanumeric code or bar code, for instance. Further, the entire coupon including the promotional code need not be sent initially. For instance, a consumer can be notified of such a coupon first with a description of the product and/or service offer. This can be termed and offer impression. Subsequently, if interested, the consumer request more details including the coupon and promotional code. In other words, the coupon can be activated. Such a request or activation can correspond to clicking on the notification to initiate download of the coupon, texting a message “GET,” sending an e-mail, or placing a call, inter alia. Further, it is to be noted that the advertisement can include or be associated with a host of other information to aid consumers including such things as an advertiser's address and phone number, a map to one or more locations and a link to the advertiser's website, for example. Still further yet, while promotional code can aid in tracking offer usage (e.g., impression, activation, impression), a unique tracking code can also be associated therewith for that purpose.

Payment component 1040 is a mechanism to enable billing or invoice generation and receipt of payment from advertisers. Similar to other advertiser components, various interfaces, graphical or otherwise, among other things, can be employed to provide such functionality. Variations are likely since a multitude of different payment agreements and/or arrangements can be employed. In accordance with one embodiment, an advertiser can be afforded an invoice generated as a function of impressions, activations, and redemptions. Impressions refer to notifications of offers. Request and receipt of the actual offer are activations, and redemptions refer to purchases made that take advantage of an offer. Additionally or alternatively, payment component 1040 can include or be associated with a separate component (not shown) to provide auction functionality to advertisers, for example to bid against each other for the right to afford a user an advertisement in a particular context. It is also to be noted that a user can provide the payment component 1040 with a budget associated with the number of impressions, activations, and/or redemptions in an attempt to cap cost.

Report component 1050 provides information about the performance of an advertisement campaign to an advertiser. For example, number of impressions, activations, and redemptions related to a promotion can be provided. Further, additional information or characteristics of particular consumers can be afforded including those that (1) received an offer but did not activate it, (2) received the offer and activated the offer but did not redeem it, and (3) received the offer, activated the offer, and redeemed the offer. Overall, such information aids advertiser in determining advertisement effectiveness and enables subsequent campaigns to be improved.

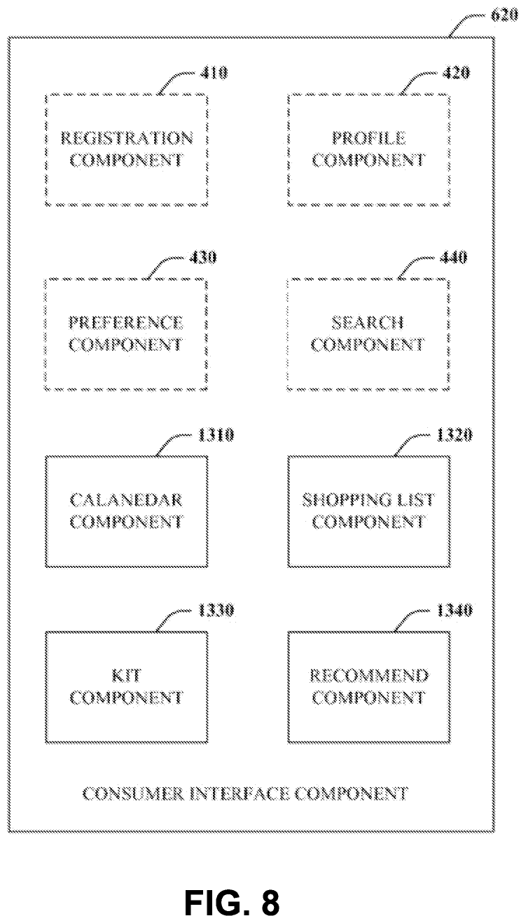

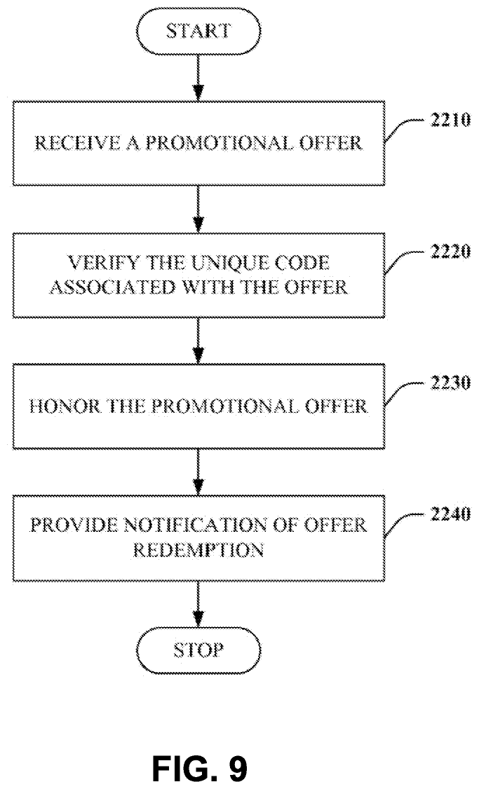

Referring to FIG. 8, a representative consumer component 620 is illustrated in accordance with an aspect of the claimed subject matter. Similar to the consumer component presented in FIG. 9, consumer component 620 includes the registration component 910, profile component 920, preference component 930, and search component 940, as previously described. Among other things, these components aid consumer interaction with a marketing system. The consumer component 620 can also include additional functionality for assisting in acquiring information, as well as providing information.

In particular, the consumer component 620 can include a calendar component 1310 that can facilitate specification and/or acquisition of consumer preferences or other event relevant information. In one embodiment, the calendar component 1310 provides a mechanism to associated preferences or filters and/or categories with particular dates including purchase events. For example, a consumer can add some categories and/or filters to a date associated with a relative's birthday. On or before that date, these filters and categories can be automatically activated. As a result, advertisements will be sent that are tailored to that event. Moreover, users need not specify particular filters but rather can simply identify particular products or services and the calendar component 1310 can automatically generates appropriate filters. Additionally or alternatively, items can be shared with others. For example, one consumer can set up a wish list or the like for events (e.g., birthday, Christmas . . . and share them with other users. Upon copying or otherwise receiving this list, the calendar can generate filters automatically and associated them with the particular event date.

Consumer component 620 can also include a shopping list component 1320 that focuses advertisement matching with respect to a particular shopping list. In one embodiment, the shopping list component can aid generation of such a list. Additionally or alternatively, a list can be otherwise acquired such as by upload, download, import or the like. Once acquired, the shopping list can be utilized to adjust categories, filters or the like that influence matching. In one implementation, adjustments based on the shopping list can override at least temporarily other setting since shopping interests are known.

Kit component 1330 enables acquisition of information about kits and employment of the information in modifying categories, filters or the like based thereon. Kits are sets of items employed for a particular purpose. Recipe kits are one example. However, kits can be much more general. For instance, a set of computer equipment including a laptop, mouse, and bag, among other peripherals can be a kit. Upon acquiring information about a desired kit, kit component 1330 identifies kit items and sets filters or the like to facilitate provisioning of promotional offers for the items to enable purchase of the kit at a low cost. It should be noted that a retailer could prepackage all kit items in an attempt to attracted such buyers and offer a discount on the collection of items. Accordingly, a promotional offer associated therewith can be sent to a potential consumer.

The consumer component 620 can also include a recommend component 1340. The subject system is not limited to providing advertisements. In addition or as an alternative, collected information can be utilized to provide retailer advertiser independent recommendations. The same or similar categories, filters, contextual information and the like that are utilized to match advertisements can be employed to simply make suggestions or simply provide valuable information. For example, if a consumer likes pizza for lunch, at lunchtime all local pizza shops can be provided to the user. In another scenario, in a meeting where a salesperson is attempting to land an important client and client representative filters, shopping lists or the like are available, the salesperson can be informed before the meeting that the chief executive officer of the potential client company likes seventeen-year-old scotch.

According to one aspect of claimed subject matter advertisements including promotional offers, coupons and the like can be provided to a user for subsequent redemption at a store. For example, as previously described, an alphanumeric or bar code style promotional code can be provided to a mobile device that can be shown input, shown, scanned or the like at a point of sale. However, claimed subject matter is not so limited in the distribution of promotional offers. In accordance with one embodiment, discounts can be provided to and saved onto loyalty cards or the like. For example, rather than or in addition to providing a promotional offer for a grocery store product to a user via an associated mobile device, the offer can be provided to and saved with respect to the grocery store loyalty card. Accordingly, the discount can be automatically taken on the product upon presentation of the loyalty card. Moreover, the coupon can be provided to multiple loyalty cards for use at more than one store and/or removed after redemption.

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the dialog component(s) 120, advertisement component 140, and analysis component 130 can all employ such mechanism to facilitate intelligent dialog, analysis, and advertisement generation, among other things. It is also to be appreciated that correlation component 650 and delivery component 660 can employ these mechanisms to infer advertisement matches and when and how to deliver matching advertisements.

While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 9 is flow chart diagram of a method of offer redemption 2200 in accordance with an aspect of the claimed subject matter. At reference numeral 2210, a promotional offer or promotional offer coupon is received. For example, at the point of sale a user can provide a promotional and/or unique tracking code (e.g., numeric, alphanumeric, bar code . . . ) verbally, visually, and/or electronically (e.g., scanner, Wi-Fi, Bluetooth . . . ). At numeral 2220, the unique code is verified, for instance by contacting a mobile marketing system from which the offer was generated. This can ensure not only that the code is valid but also other offer stipulations are satisfied (e.g., validity dates, other product purchases . . . ). At reference 2230, the promotional offer is honored for example by discounting the price of a product or service. Subsequently or concurrently, at 2240, notification is provided of offer redemption. For example, mobile marketing system or some other service can be notified. In one instance, a specific database can be updated to reflect the honoring of the offer.

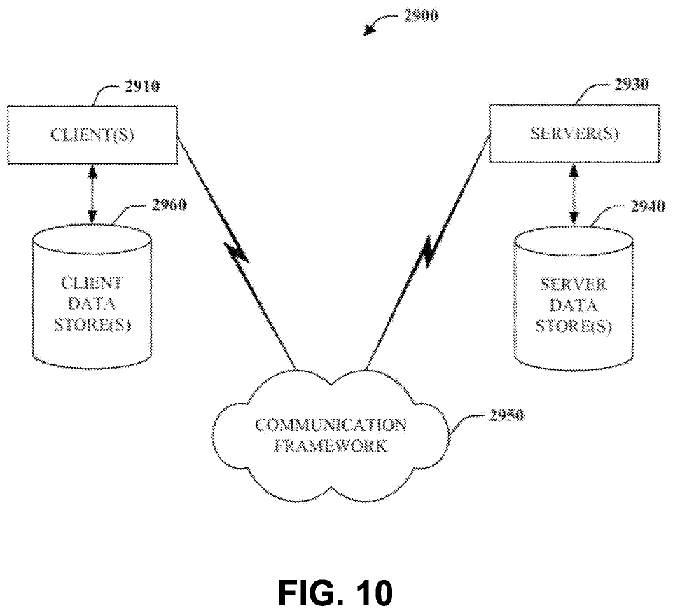

FIG. 10 is a schematic block diagram of a sample-computing environment 2900 with which the subject innovation can interact. The system 2900 includes one or more client(s) 2910. The client(s) 2910 can be hardware and/or software (e.g., threads, processes, computing devices). The system 2900 also includes one or more server(s) 2930. Thus, system 2900 can correspond to a two-tier client server model or a multi-tier model (e.g., client, middle tier server, data server), amongst other models. The server(s) 2930 can also be hardware and/or software (e.g., threads, processes, computing devices). The servers 2930 can house threads to perform transformations by employing the aspects of the subject innovation, for example. One possible communication between a client 2910 and a server 2930 may be in the form of a data packet transmitted between two or more computer processes.

The system 2900 includes a communication framework 2950 that can be employed to facilitate communications between the client(s) 2910 and the server(s) 2930. The framework 2950 can include one or more of many wired and/or wireless communication means including without limitation the Internet and cellular technologies, among others. The client(s) 2910 are operatively connected to one or more client data store(s) 2960 that can be employed to store information local to the client(s) 2910. Similarly, the server(s) 2930 are operatively connected to one or more server data store(s) 2940 that can be employed to store information local to the servers 2930.

Client/server interactions can be utilized with respect with respect to various aspects of the claimed subject matter. By way of example and not limitation, the client(s) 2910 can correspond to a user computer or mobile device such as a phone, which is able to communicate with a mobile marketing system or at least a subset of such functionality executed by one or more servers 2930 across the communication framework 2950. Further, the server(s) 2930 can afford a mobile application comprising mobile marketing functionality that can be downloaded over the communication framework 2950 and subsequently installed by the client(s) 2910. Further yet, all or portions of the mobile marketing system can be hosted by one or more servers 2930 and accessible via one or more clients 2910 including mobile and other computer devices to facilitate input consumer and advertiser information (e.g., profiles, preferences, setting), for example through an online website.

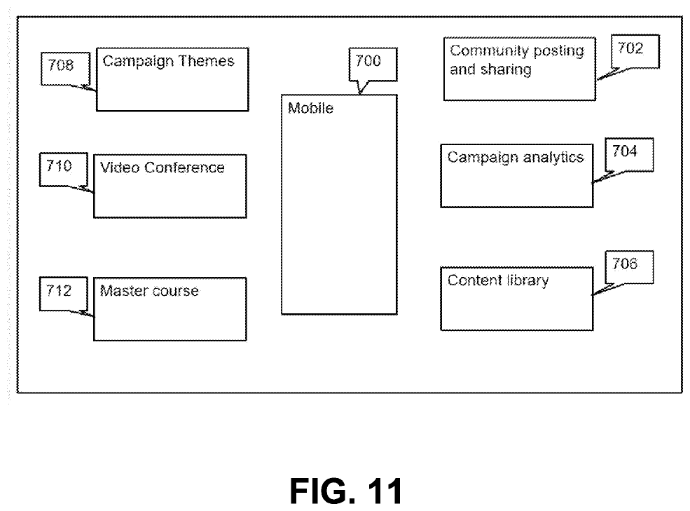

FIG. 11 explains the list of the concept which are covered. For Example owner of Mobile device (700) shall engage in the following activities for business development such as Community posting and sharing (702), Campaign analytics (704), Content library (706), Campaign Themes (708), Video Conference (710), Master course (712) for sharing the business knowledge.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

Furthermore, to the extent that the terms “includes,” “contains,” “has,” “having,” or variations in form thereof are used in either the detailed description or the claims, such terms are intended to be inclusive in a manner similar to the term “comprising” as “comprising” is interpreted when employed as a transitional word in a claim.

We claim:

1. A method for providing white label network branding to control monetization program by using internet and mobile websites and related mobile device or computer systems comprising promotions, online coupons, mobile services, Products, Goods & Services, and related company and local information, using a mapping platform using multi-dimensional and scalable mapping, said method comprising:
electronically assigning on a computer system an identifier to a client mobile device or computer receiving a request;
electronically providing on a mobile device or computer system access to said websites or links that provide mapping combination of integrated social networking, social networking communities, social networking activities, user profiles;
electronically connected by mobile App management which allow subscribers or their private communities the ability to download, share, and have direct access to exclusive content that can be monetized to their community or subscribers;
electronically connected to subscribers by Advertisement that control and manage the advertisements that your subscribers or community view on their dashboard;
electronically connected to subscribers by way of Virtual learning management by which subscribers can create own university course study in business and leadership, photography, cooking, writing, acting, music, sports and more;
electronically connected to subscribers by way of providing Content management which can be managed by branding “Paid Subscribers”, “Privilege Customers” and managing the content in the platform;
electronically connected to subscribers by way of Campaign Themes and Capture pages, also connecting the subscribers by way of online questionnaires;
electronically connected to subscribers by way of community posting and sharing;
electronically connected to subscribers by way of content library to access the latest uploads, videos, media uploaded by the platform owner;
electronically connected to subscribers by way of Campaign analytics;
electronically connected to subscribers by way of E-wallet management via a dashboard which can access via your mobile phone or computer, wherein the wallet shall manage the rewards, digital currency and act as a payment to subscribers and community for referral commission payments and rewards, closed looped e-wallet platform will be for “netWO” rewards, payments and incentive programs to build communities and revenue channels, with an integrated payment gateway for crypto and fiat payments and overrides.

2. The method as claimed in claim 1, wherein said method comprises providing remote computing or mobile device or computer system access and wherein said interactive links are selected from Internet sites, feeds, pictures, videos, audio clips, social network, social networking, social networking communities, social networking activities, online communications, messaging, user profiles, viewing public & private user profiles, social plugins, promotions, social applications, entertainment shopping.

3. A method of mobile marketing, comprising:
employing a processor executing computer executable instructions to implement the following acts:
presenting one or more one-off questions to a user on a mobile device as a function of current context;
storing responses to the questions to a database;
analyzing database data including the responses, user profiles, user preferences, and transaction history to identify micro segments; and
classifying users as members one or more micro segments.

4. The method as claimed in claim 3, comprising requesting a user rate a product or service.

5. The method as claimed in claim 3, comprising generating a question as a function of a response to a previous question.

6. The method as claimed in claim 3, comprising providing the user with an incentive to respond to the one or more questions.

7. The method as claimed in claim 3, comprising predicatively matching a promotional offer to a user as a function of a micro segments of which the user is deemed a member.

8. The method as claimed in claim 3, comprising receiving a test advertisement and identifying a number of user matches produced by the advertisement.

9. The method as claimed in claim 3, comprising identifying an unmet need and notifying an advertiser thereof.

10. The method as claimed in claim 9, comprising automatically generating a promotional offer for an advertiser to address the unmet need.

11. A method of marketing goods or services, comprising:
employing a processor executing computer executable instructions to implement the following acts:
acquiring user profiles and preferences, electronic coupons, and advertiser preferences that control dissemination of the coupons;
monitoring transactional history of users with respect to the coupons including coupon notification, activation, and redemption;
classifying the users into affinity groups based on at least one of profiles, preferences, or transactional history; and
matching the coupons to users as a function of at least the group classification and advertiser preferences.

12. The method as claimed in claim 10, comprising engaging individual users in a real-time dialog based on current context and known information to acquire additional information to facilitate at least one of classifying the users or matching the coupons.

13. The method as claimed in claim 11, comprising delivering the coupons electronically to mobile devices associated with the matching users.

14. A computer-implemented marketing system, comprising:
a dialog component that establishes an electronic dialog with a user to acquire discrete pieces of information and saves the acquired information to one or more data stores;
a correlation component that matches advertiser coupons to users as a function of at least to the acquired information; and
a delivery component that delivers an electronic coupon to mobile devices associated with matching users.

15. The system as claimed in claim 14, the dialog component acquires feedback about at least one of an advertiser or advertisement.

16. The system as claimed in claim 14, comprising a question component that generates one or more user specific questions designed to retrieve information about a user's specific needs or desires.

17. The system as claimed in claim 16, comprising a response component that analyzes a response to the one more questions and provides information to the question component to aid generation of subsequent questions as a function of previously responses to questions.

18. The system as claimed in claim 14, comprises a component that provides an incentive to a user to engage in electronic dialog.

19. The system as claimed in claim 18, the dialog component is activated at a point of sale and an electronic coupon can be afforded in exchange for engaging in the dialog.

20. The system as claimed in claim 14, comprising an analysis component that analyzes database data associated with individuals and classifies them into affinity groups or segments that are utilized by the correlation component to predicatively match coupons to users.

21. The system as claimed in claim 14, comprising a component that analyses information in the database and identifies effective promotions.

22. The system as claimed in claim 21, comprising a component that automatically generates a coupon for an advertiser based on an identified promotion.
